(19) United States
(12) Patent Application Publication
(10) Pub. No.: US 2009/0036169 A1
(43) Pub. Date: Feb. 5, 2009

(54) MOTOR VEHICLE CORDLESS HANDS-FREE KITS

(75) Inventor: Olivier Philippe, Colombes (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/282,348

(22) PCT Filed: Feb. 19, 2007
(86) PCT No.: PCT/FR07/50818

§ 371 Date: Sep. 9, 2008

(30) Foreign Application Priority Data
Mar. 10, 2006 (FR) 0650813

(51) Int. Cl. H04M 1/00; H04B 1/00

(52) U.S. Cl. 455/569.2; 381/86

(57) ABSTRACT

The improved cordless “hands-free” kit system for a motor vehicle comprises a cordless “hands-free” kit (1), associated with the multimedia facilities (2, 3) of the vehicle. The cordless “hands-free” kit (1) serves as “gateway” equipment between these facilities of the vehicle and audio roaming equipment (5, 8). The system has applications in motor vehicles, multimedia equipment for motor vehicles, telephony for motor vehicles.

The present invention relates to improvements to so-called motor vehicle wireless hands-free kits. More particularly, it relates to the technical field of new uses of these systems.

The hands-free kit is a highly recommended accessory for making in-car telephone calls, due to the ban prohibiting drivers from using a hand-held telephone in traffic. As an add-on, it is composed of a speaker and a microphone. Factory installed, it is composed of a microphone and interfaces with the vehicle audio system, these fittings enabling both hands to remain on the steering wheel during a telephone call.

Bluetooth® technology has revolutionized the concept of hands-free kits by establishing a transparent, wireless connection between the driver's telephone and the car kit: the so-called wireless hands-free kit is what enables the reception of telephony on the motor vehicle's speakers.

Consequently, this system is coupled with various elements:
the sound management member (radio, radio navigation, high fidelity amplifier, etc.)
the graphic readout member for displaying windows devoted to the telephony function (multifunction screen, navigation screen, etc.)
the control member on the steering column.

As soon as the vehicle starts, the hands-free kit—which can also be designated by the name HFK in the rest of the text—automatically recognizes the driver's mobile telephone and connects it. It provides real hands-free management for in-car phone calls. The driver simply pronounces the phone number of the person to call out loud, and the HFK dials the number. And if the number of the party to call is already recorded in an address book of the telephone, the driver simply pronounces his name. An information screen at eye level—for example, on the dashboard or near the rear view mirror—displays the identity of the caller.

Mobile products—particularly, but not exclusively mobile audio products—are undergoing exponential development.

For this reason, there has been an effort to extend their applications. And this search for new applications is especially relevant to the automotive realm.

According to French patent application no. 2 868 235, a device is known for playback of compressed digital multimedia files such as Mp3, JPEG, DivX and others, and for conducting phone calls as with a handset or a hands-free kit from a mobile or stationary telephone. This device has a multimedia drive and a Bluetooth®-type radio module. The incoming telephone call can be redirected to the device using the Bluetooth® radio link. The device has various additional functions. Two or more devices of this type can communicate with one another. The device can also make calls, record multimedia files, and have FM radio and clock functions.

Such a device, however, is autonomous, not an automotive device. It cannot be incorporated into an existing automotive system with a multifunction display (MFD) and a radio. In other words, this device can be installed in a motor vehicle, but only in a completely autonomous way, without making use of existing automotive equipment such as a radio, speakers, screen, and a steering column control. Moreover, this device does not have the control capabilities for wireless mobile equipment (telephone, audio drive, smartphone), meaning the ability to change audio tracks, to pause, fast forward or rewind, etc., from the system to the mobile equipment.

According to United States patent publication US 2003/0114202 A1, a system is also known for providing comfort and safety for a telephone call from a mobile phone while driving. This system has a communication module for transmitting wireless character and voice data between the hands-free system and the portable telephone without any need for a physical connection. The method described in this publication enables input on the portable phone to be recorded in the system, and makes it possible to conduct a telephone call on the portable phone by using the system. It is thus a “wireless telephone hands-free kit” type of system that is autonomous, and is not installed on existing automotive equipment, either. There is also the fact that this prior art device has no added functional capabilities, such as music playback capability, for example.

According to United States patent publication US 2005/0008147 A1, a hands-free wireless earphone device is also known, intended to be used while driving a vehicle. This device has a transceiver adapted to be detachably connected to a portable telephone, a hands-free earphone for wearing on one ear to receive and send voice frequency signals to and from the transceiver, and a speaker dock to removably hold the earphone. When the hands-free earphone is set on the dock, the voice frequency signals are redirected to and sent out via the dock. With the dock, a user can converse while driving without having to wear the earphone on his ear. Beyond the strict application of the wireless hands-free kit, this device does have audio playback, but without any real expansion of functional capabilities.

A goal of the present invention is to design an improved wireless hands-free kit system that has additional capabilities relative to the prior art wireless hands-free kits.

Another goal of the present invention is to design an improved wireless hands-free kit system that has additional capabilities relating to the wireless connection with mobile equipment, i.e., with the portable communication equipment of the driver, or more generally, of the motor vehicle occupants.

Another goal of the present invention is to design an improved wireless hands-free kit system that has additional capabilities for managing and controlling mobile audio equipment.

Yet another goal of the present invention is to design an improved wireless hands-free kit system that has additional capabilities relating to playing back sound from the vehicle sound sources on mobile playback equipment.

It is yet another goal of the present invention to design an improved wireless hands-free kit system that can be installed in a motor vehicle, with all of its additional capabilities, reusing the automotive equipment present in the vehicle.

In order to achieve these goals, the invention proposes a new improved wireless hands-free kit system in which the wireless hands-free kit serves as “bridging” equipment between the multimedia elements of the vehicle and mobile audio equipment.

According to a first series of novel added functions of the improved wireless hands-free kit according to the present invention, the mobile equipment has emission functions and the vehicle multimedia equipment has reception functions.

This mobile equipment can be a wireless telephone connected to the wireless hands-free kit through a wireless connection.

In addition to the wireless telephone or separately, this equipment can also be a wireless audio source connected to the wireless hands-free kit by a wireless connection.

The wireless hands-free kit is then coupled to a sound management member, a graphic readout member, and the control member on the steering column.

The mobile equipment is preferably controlled using the vehicle's existing steering column control buttons or radio buttons.

The wireless connections between the mobile equipment and the hands-free kit can be Bluetooth®-type wireless connections or other kinds of digital wireless technology such as ultra-wideband technology, known as UWB technology (for “Ultra-Wide Band”).

According to a preferred embodiment of the invention, the wireless audio source playlists (groupings of preselected tracks), all or part of the track information (length, title, artist, etc.) and the time elapsed are displayed on the vehicle graphic readout member.

Also according to this preferred embodiment, the sound management member provides audio playback of the mobile equipment audio transmissions on the vehicle speakers.

According to a second series of novel added functions of the improved wireless hands-free kit according to the present invention, the mobile equipment has playback functions and the vehicle equipment has emission functions.

The improved wireless hands-free kit then makes it possible to listen to the vehicle audio sources on said mobile playback equipment.

This mobile playback equipment can have a wireless headset connected to the hands-free kit by a wireless connection.

In addition to the wireless headset or separately, this equipment can also be a wireless telephone connected to the hands-free kit by a wireless connection.

The mobile equipment can be controlled using the vehicle steering column controls and/or radio controls.

A vehicle readout screen can be used to display the information on the state of the mobile playback equipment.

By preference, the wireless headset can be equipped with an automotive-specific Human-Machine Interface (HMI), which can be a pushbutton for choosing the vehicle audio source to which the user wants to listen: radio, CD, DVD, vehicle telephone, etc.

The wireless connections between the mobile playback equipment and the hands-free kit can be Bluetooth®-type wireless connections or UWB-type wireless connections.

The sound management member can be one or more of the following members: radio, vehicle radio navigation, high fidelity amplifier.

The graphic readout member for displaying windows devoted to the telephony function is one or more of the following members: multifunction screen, navigation screen.

Other purposes, advantages and characteristics of the invention will appear in the following description of a preferred, non-limiting embodiment of the object and scope of the present patent application, accompanied by drawings in which:

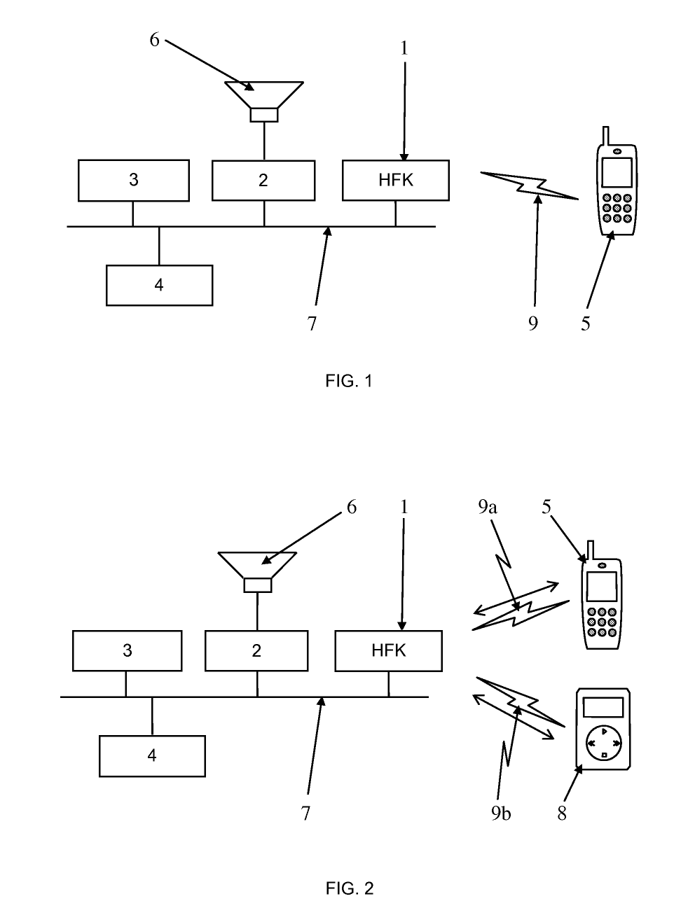

FIG. 1 is a diagram showing the general structure of an automotive wireless hands-free kit system according to prior art,

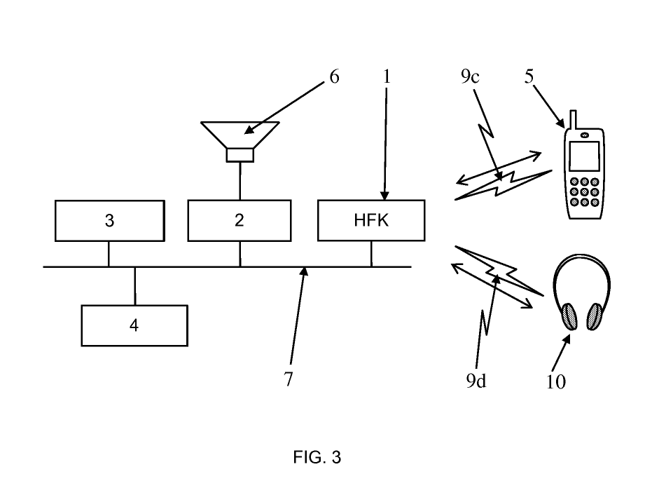

FIG. 2 is a diagram showing the general structure of an improved automotive wireless hands-free kit system, and illustrating a first series of additional capabilities according to the object of the present invention,

FIG. 3 is a diagram showing the general structure of an improved automotive wireless hands-free kit system, and illustrating a second series of additional capabilities according to the object of the present invention.

As previously mentioned, a known, widespread automotive wireless hands-free kit system according to prior art has a general structure like that shown in the diagram in FIG. 1. The wireless hands-free kit (HFK), referenced 1, is coupled to the sound management member 2 (radio, vehicle radio navigation, high fidelity amplifier, etc.), to the graphic readout member 3 in order to display windows devoted to the telephony function (multifunction screen, navigation screen, etc.) and to the steering column control member 4. Reference 5 shows the mobile equipment, namely the user's portable telephone, which communicates with the wireless hands-free kit 1 by means of a Bluetooth®-type wireless connection 9 or some other kind of wireless connection, such as a UWB-type digital wireless connection. The sound management member 2 is connected to the speakers 6 in the vehicle passenger compartment. The hands-free kit 1 and the members 2, 3, 4 and 6 are connected with one another via the vehicle network 7, e.g., the CAN bus (communication protocol linking the automotive equipment).

The present invention consists in using the wireless hands-free kit member 1 and the associated vehicle system, while adding supplemental capabilities.

A first series of additional capabilities works from an audio stream input going from the mobile equipment to the wireless hands-free kit 1. Referring to the diagram in FIG. 2, the mobile equipment can be a wireless telephone 5 and/or a wireless audio source 8 (e.g., a digital Mp3 player), connected to the wireless hands-free kit 1 via a wireless Bluetooth®-type connection, namely, a wireless connection 9a for the wireless telephone 5 and a wireless connection 9b for the wireless audio source 8. The mobile equipment, i.e., the wireless telephone 5 or the audio source 8, is controlled using the existing steering column control buttons or the radio buttons. The playlists, the track titles and all the information related to the track titles (artist, date, etc.), the track length and the time elapsed are displayed on the vehicle screen. The radio provides audio playback on the vehicle speakers. For all these reasons, it is easy to see that everything functions as if the wireless hands-free kit member 1 were acting as a bridge between the vehicle members and the mobile audio sources.

The present invention offers a second series of additional capabilities, illustrated by the general structural diagram of the improved wireless hands-free kit 1 in FIG. 3.

This second series of additional capabilities works from an audio stream output going from the wireless hands-free kit 1 to the mobile equipment.

The system of the invention thus makes it possible to listen to the vehicle audio sources on mobile playback equipment, such as a wireless headset 10. The mobile equipment, 5 and 10, is connected to the wireless hands-free kit 1 by a wireless Bluetooth®-type connection, namely, a wireless connection 9c for the wireless telephone 5 and a wireless connection 9d for the wireless headset 10. In operation, the system consists in reusing:
the steering column controls 4 and/or the radio controls for controlling the mobile playback equipment.
the vehicle readout screen for displaying the information on the state of the mobile playback equipment (active or not, source used, etc.)

As a variant, each wireless headset 10 can be equipped with an automotive-specific Human-Machine Interface (HMI), e.g., a pushbutton for choosing the vehicle audio source to which the user wants to listen: radio, CD, DVD, vehicle telephone, etc.

With each push of a button, a command is sent to the wireless hands-free kit 1, which is then responsible for redirecting the information onto the vehicle network 7 to the correct recipient.

Thus, for this second series of additional capabilities, just as for the first series, everything also functions as if the wireless hands-free kit member 1 were acting as a bridge between the vehicle members and the mobile audio sources.

The present invention offers numerous advantages. First, the existing vehicle wireless hands-free kit member can be reused by treating it as a bridge between the existing vehicle equipment (radio, screen, steering column control) and the mobile equipment (wireless telephone, wireless audio sources, etc.). This improvement to the vehicle wireless hands-free kit also offers an easier way to assemble an array of customer features (hands-free kit, mobile audio playback, separate driver/passenger audio playback, etc.) at a lower cost, since the member exists. There is thus no need to completely develop this “wireless bridge”.

1. Improved wireless hands-free kit system for a motor vehicle, comprising a wireless hands-free kit, multimedia members of the vehicle, wherein the wireless hands-free kit serves as “bridging” equipment between a) said vehicle members via a vehicle network and b) mobile audio equipment via at least one wireless connection wherein some of said mobile equipment has emission functions and some of said vehicle multimedia members have reception functions, and wherein some of said mobile equipment has playback functions and some of said vehicle multimedia members have emission functions.

2. Improved wireless hands-free kit system according to claim 1, wherein said mobile equipment is a wireless telephone connected to the wireless hands-free kit via a wireless connection.

3. Improved wireless hands-free kit system according to claim 2, wherein said mobile equipment is additionally a wireless audio source connected to the wireless hands-free kit via a wireless connections.

4. Improved wireless hands-free kit system according to claim 1, wherein said vehicle multimedia members comprise a sound management member, a graphic readout member and a steering column control member.

5. Improved wireless hands-free kit system according to claim 1, wherein the mobile equipment is controlled using the vehicle's existing steering column control buttons or radio buttons.

6. Improved wireless hands-free kit system according to claim 2, wherein said wireless connections between said mobile equipment and the hands-free kit are Bluetooth®-type wireless connections.

7. Improved wireless hands-free kit system according to claim 2 wherein said wireless connections between said mobile equipment and the hands-free kit are UWB “Ultra-Wideband” technology wireless connections.

8. Improved wireless hands-free kit system according to claim 3 wherein the playlists, all or part of the wireless audio source track information and the time elapsed are displayed on the vehicle graphic readout member.

9. Improved wireless hands-free kit system according to claim 4, wherein the audio playback of the mobile equipment audio transmissions is provided by the sound management member on the vehicle speakers.

10. Improved wireless hands-free kit system according to claim 9, which makes it possible to listen to the vehicle audio sources on said mobile playback equipment.

11. Improved wireless hands-free kit system according to claim 10, wherein said mobile playback equipment has a wireless headset connected to the hands-free kit via a wireless connection.

12. Improved wireless hands-free kit system according to claim 10, wherein said mobile playback equipment has a wireless telephone connected to the hands-free kit via a wireless connection.

13. Improved wireless hands-free kit system according to claim 9, wherein the mobile equipment is controlled using the vehicle steering column controls and/or radio controls.

14. Improved wireless hands-free kit system according to claim 9, wherein the vehicle readout screen can be used to display the information about the state of the mobile playback equipment.

15. Improved wireless hands-free kit system according to claim 11, wherein said wireless headset is equipped with an automotive-specific Human-Machine Interface.

16. Improved wireless hands-free kit system according to claim 15, wherein said automotive-specific Human-Machine Interface is a pushbutton that allows the user to choose the vehicle audio source to which he wants to listen.

17. Improved wireless hands-free kit system according to claim 11, wherein the wireless connections between the mobile playback equipment and the hands-free kit are Bluetooth®-type wireless connections.

18. Improved wireless hands-free kit system according to claim 11, wherein the wireless connections between the mobile playback equipment and the hands-free kit are UWB “Ultra-Wideband” technology wireless connections.

19. Improved wireless hands-free kit system according to claim 4, wherein the sound management member is one or more of the following members: radio, vehicle radio navigation, high fidelity amplifier.

20. Improved wireless hands-free kit system according to claim 4, wherein the graphic readout member for displaying windows devoted to the telephony function is one or more of the following members: multifunction screen, navigation screen.
